(19) United States
(12) Patent Application Publication
(10) Pub. No.: US 2008/0114567 A1
(43) Pub. Date: May 15, 2008

(54) Sequential sampling within a portable computing environment

(76) Inventors: Daniel R. Jeske, Riverside, CA (US); Pengyue J. Lin, Riverside, CA (US); Robert F. Luck, Riverside, CA (US); Arunava Chakravartty, Indianapolis, IN (US); Payal Shah, Corona, CA (US); Carlos Rendon, Riverside, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/982,818

(22) Filed: Nov. 5, 2007

Related U.S. Application Data
(60) Provisional application No. 60/856,616, filed on Nov. 3, 2006.

(51) Int. Cl. G06F 17/18

(52) U.S. Cl. 702/179

(57) ABSTRACT

A sequential sampling tool that executes advanced sequential protocols on a portable platform. The system includes a computer and software code compiled with well-known statistical and graphical user interface packages. The sampling and testing tool supports SPRT, 2-SPRT, and sequential Bayes sampling protocols for a variety of statistical distributions, including Bernoulli, binomial, Poisson, negative binomial, and normal distributions. The user has easy access to properties of the statistical design, such as average sample size curve, the operating characteristic curve, and the Type-1 and Type-2 error rates. The system also displays two boundary lines for the design, and allows the user to plot and visualize each observation point one-at-a-time as each sample unit is taken and counted.

### CROSS-REFERENCES TO RELATED APPLICATIONS

This application claims priority from U.S. Provisional Application Ser. No. 60/856,616, filed Nov. 3, 2006 incorporated by reference in its entirety.

### BACKGROUND OF THE INVENTION

The present invention is directed to systems and methods for sequential sampling and hypothesis testing, and more particularly to industrial, agricultural, warehouse/retail settings, data network systems, medical and pharmaceutical manufacturing, world-wide disease surveillance and control, general consumer for self-monitoring health indicators and other systems and environments where sequential sampling and hypothesis testing could markedly improve productivity and quality control. The underlying mathematics can be very complicated; however, leading to very high computing requirements. Also, the logistics of sequential data collection is difficult. Thus, existing systems typically use simplified protocols (e.g., fixed sample sizes) or use advanced hardware that is relatively expensive and immobile.

By way of example, but not intended to be limiting, the application of systems and methods for sequential sampling and hypothesis testing includes providing an effective integrated or sustainable pest management program as an efficient means of assessing pest densities along with their likely economic impact on a crop. Pest management is an economic endeavor and, as such, it is part of the cost of producing an agricultural commodity. Pest assessment seeks to reduce pest management costs by reducing the uncertainty about whether or not a pest is sufficiently dense to cause economic damage to the crop. Equally important, such assessments also seek to minimize the unnecessary use of a control measure when pest densities are below a critical density because they increase production costs or in the case of chemical pesticides, they increase environmental and other extra-market costs. Unnecessary pest control with these materials often interferes with suppression of other potential pests by resident natural enemies or creates a vacuum that eventually spawns new pest populations that can be more challenging than those for which the initial pesticide application was used. Unnecessary treatments can be largely eliminated with an appropriate pest assessment protocol.

Pest assessment protocols must be cost effective; that is, they must cost less to acquire the information needed for a prudent decision than it costs to routinely treat a pest or to endure the economic loss by always ignoring the pest. The need for such a cost effective approach to pest assessment has led to the development of efficient statistical sampling plans; the most prevalent of which are those involving sequential designs. The most commonly used designs have been the standard sequential probability ratio test (SPRT) (see, Binns, M. R., Sequential Sampling For Classifying Pest Status, pp. 137-174, 1994, incorporated herein in its entirety by reference).

Using an SPRT design involves obtaining pest counts from individual sampling units (e.g., leaves or fruit) and counting the number of pests on that unit. This count is then added to the previous counts and plotted, i.e., the cumulative sum of these counts are plotted on the y-axis. The sample number, i.e. the number of units (leaves or fruit) that have evaluated up to that point is plotted on the x-axis. As long as the plotted points remain between the two parallel lines, the sampling procedure continues. If the plotted points intersect the top line, a decision is made to treat the pest density because it exceeds the economic threshold. Alternatively, if the plotted points intersect the lower line, then a decision is made not to treat the pest because it is below the point where it would cause economic losses.

SPRT protocols may be designed to detect and classify pest population densities efficiently and with minimum effort commensurate with classifying a pest's density as economic or uneconomic. They allocate the least sampling effort to fields or groves in which pest populations are dense (economic) or sparse (non-economic) and allocate maximal effort to fields in which pest populations are near their economic density. When pest populations are dense or sparse, only a few samples are usually needed to determine the pest's status. Alternatively, when pest populations are near their critical densities (i.e., close to or just exceeding their economic densities) the SPRT calls for an increased effort (more leaves) to determine whether intervention is needed. In addition, the SPRT sampling procedure also guards against two types of misclassification mistakes, (error rates); 1) a Type-1 error (i.e., the probability of incorrectly deciding to control a pest when such control is unnecessary), and 2) a Type-2 error (i.e., the probability of deciding against controlling the pest when control is needed). The error rates are set by the consequences of making such an error and the statistical probability distributions describing the pests distribution among the sample units (e.g., among the leaves or fruits).

In a field with a given pest density, the number of samples required to classify the pest density will vary if the field is repeatedly sampled. This occurs because the number of leaves required to classify the field depends on the specific pattern of infested and un-infested leaves. A repeated sample of the same field or plot will almost certainly involve a different set of leaves each with a different number of pests (or no pests) on the leaves comprising that particular sample. Thus, the number of leaves required before a field can be classified will vary. For example, if a given pest species typically occurs as clusters on some sample units (e.g., leaves) while many of the units have very few or no pests, then more leaves (i.e., samples) will be required on average than if a pest occurs as one or two individuals per leaf, that is, they are not likely to be scattered as clusters. The sampling of units (e.g., leaves) continues, until the accumulated number of pests and leaves produces a point that crosses one of the parallel lines. To judge the sampling effort required to classify a field (i.e., crosses the SPRT boundary lines), the concept of average sample number (ASN) is used to reflect the expected number or samples that will be needed before a boundary is crossed.

Another two examples for the application of systems and methods for sequential sampling and hypothesis testing include the sampling strategy for manufacturing industries and medical studies. Acceptance sampling is a decision-making tool by which a conclusion is reached concerning the acceptability of the product, process or system state by a manufacturing company to manage the quality of raw materials from their suppliers. In medical studies that involve humans (or animals) there is an ethical need to stop the study if treatment results suggest harmful effects and to introduce the therapy to larger populations if the results suggest benefits. In any experiment or survey where data accumulates steadily over a period of time, it is natural to monitor results as they occur with a view to taking action such as early termination or some modification of the study design. If a new therapy does not reveal advantages over existing therapies, it is important to not conclude that as quickly as possible and move on to alternatives that might be more promising. Curtailed sampling is more economical, as resources are not wasted when the outcome (positive or negative) is no longer in doubt. Moreover, appropriate action corresponding to a conclusion can be implemented faster, resulting in additional savings.

An aspect of using SPRT that can be troubling to practitioners is that they do not know in advance the worst case sample size they will have to take. Although ASN gives the average number of samples that will be required, a particular application of SPRT could require a significantly larger number of samples than the ASN before a boundary is crossed. To deal with this problem a second type of sequential probability ratio test protocol (2-SPRT) was designed to limit the maximum sample size before a decision is made (see Lorden, G., 2-SPRT and the Modified Kiefer-Weiss Problem of Minimizing the Expected Sample Size, Annals of Statistics, 4, pp. 281-291, 1976 incorporated herein in its entirety by reference).

Using a 2-SPRT protocol is similar to using the SPRT protocol: cumulative pest counts are plotted (e.g., number of pests per leaf) against the accumulated number of sample units (the number of leaves on which the pests have so far been counted). In contrast to the parallel decision lines in SPRT, those in the 2-SPRT protocol converge to a point of intersection. Because the lines converge, the total number of samples taken is bounded by the value on the x-axis where the lines converge. The 2-SPRT trades off slightly higher sample sizes when pest densities are extremely sparse or dense for the comfort of having a known maximum sample size when the pest density assumes values close to an economic density (i.e., near the critical threshold).

There is a need for, and what was heretofore unavailable, a compact, portable system that can implement dynamic sequential decision-making protocols with flexible sampling and statistical testing. The present invention satisfies these and other needs.

### SUMMARY OF THE INVENTION

The present invention is directed to a sequential sampling and testing tool that can execute advanced dynamic protocols on a convenient portable platform. Embodiments of this sequential sampling system include software code compiled with well-known statistical and graphical user interface packages configured to run on laptop or handheld computers. One embodiment incorporating the present invention uses Java as a programming language to code the statistical computing module and user interface. The Java software can run on any computer (e.g., handheld, desktop, laptop, tablet) as long as it runs Windows XP series or Linux operating system.

The system and method of the present invention include a computer and software code compiled with well-known statistical and graphical user interface packages. The sampling and testing tool supports SPRT, 2-SPRT, and sequential Bayes sampling protocols for a variety of statistical distributions, including Bernoulli, binomial, Poisson, negative binomial, and normal distributions. The user has easy access to properties of the statistical design, such as average sample size curve, the operating characteristic curve, and the Type-1 and Type-2 error rates. The system also displays two boundary lines for the design, and allows the user to plot and visualize each observation point one-at-a-time as each sample unit is taken and counted.

One embodiment of the system and method incorporating the present invention uses Java as a programming language, wherein the software code is configured into two modules, a graphics user interface (GUI) and a statistics number processor. This design allows one having ordinary skill in the art to adapt the software to a web base system using HTTP and application servers such as Apache and Tomcat. To make the development in Java easier, open source libraries have been used. Examples of the libraries, include: (1) “SWT” for the GUI; (2) “SWTLoader” to make it easier to use SWT; (3) “fatjar” to package; (4) “ostermillerutils” to read .csv files; (5) “jfreechart” for charts/graphs; and (6) “colt” for random number generation and other numerical algorithms. The Java software of the system of the present invention is configured to run on Windows XP and Linux environments. It runs on desktop, laptop and ultra mobile personal computer (UMPC). The system has been tested on Windows XP and Linux based laptops and desktops, and Sony VAIO UX280P UMPC—Intel Centrino Core Solo U1400 1.2 GHz, Bluetooth, 802.11a/b/g Wireless, Wireless WAN, 1 GB DDR2, 40 GB HDD, 4.5″ WSVGA, Windows XP Pro SP2.

The systems and methods for sequential sampling and hypothesis testing of the present invention may be used in a pest monitoring application, where sequential sampling and analysis of the density of citrus pests like citricola scale and California red scale could enable one to accurately assess the threat posed by these pests and thus spray pesticides in a more economical manner. The prototype system processes input data in real time and displays instructions to the user as to whether or not to take additional samples, significantly reducing the burden of data collection as compared to fixed-size sampling methods. This system and method has the potential to reduce the costs of active pest monitoring to the point where it becomes a cost-effective means for optimizing the application of pesticides. The system and method may be applied to other applications, such as other agricultural, industrial, and warehouse/retail settings. Non-statistical GPS features, such as sample position tracking and grove-sector management, could included as value-added propositions to the core algorithms of the present invention

The systems and methods for sequential sampling and hypothesis testing of the present invention may be further adapted for manufacturing industries and medical studies. Acceptance sampling is a decision-making tool by which a conclusion is reached concerning the acceptability of the product, process or system state by a manufacturing company to manage the quality of raw materials from their suppliers. In medical studies that involve humans (or animals) there is an ethical need to stop the study if treatment results suggest harmful effects and to introduce the therapy to larger populations if the results suggest benefits. In any experiment or survey where data accumulates steadily over a period of time, it is natural to monitor results as they occur with a view to taking action such as early termination or some modification of the study design. If a new therapy does not reveal advantages over existing therapies, it is important to not conclude that as quickly as possible and move on to alternatives that might be more promising. Curtailed sampling is more economical, as resources are not wasted when the outcome (positive or negative) is no longer in doubt. Moreover, appropriate action corresponding to a conclusion can be implemented faster, resulting in additional savings.

The sampling and testing tool of the present invention supports SPRT, 2-SPRT, and sequential sampling protocols for a variety of statistical distributions, including Bernoulli, binomial, Poisson, negative binomial, and normal distributions. The user has easy access to properties of the statistical design, such as average sample size and the Type-1 and Type-2 errors for the design. It also displays two boundary lines for the design, and allows the user to plot and visualize each sample point one-at-a-time as each sample unit is taken and counted. When points cross over one of the two boundaries, the tool alerts the user as to which of the two hypotheses is more likely. The software can also export data to common file formats used for reports. The system and method of the present invention may be adapted such that that this range of functionality could be realized in an even more compact device. For example, one could manufacture a handheld version of the tool with an embedded operating system that would be capable of running the software of the present invention.

In addition to the pest assessment & control application supported by the original prototype of the present invention, such a system and method may find use in quality control and product acceptance testing applications, particularly in applications where the hardware needs to be portable and the hypothesis testing must be carried out in real time. An advantage of the sampling & testing tool of the present invention is that it enables the use complex sequential sampling methods in a relatively inexpensive portable computer. This invention potentially only requires a proprietary software module to be combined with off-the-shelf hardware and supporting software components, facilitating the development of different versions of the tool for different applications and for a variety of hardware platforms and operating systems.

An opportunity exists to utilize and employ sequential sampling procedures for hypothesis testing by making use of new portable computing technology. Although portable, a laptop is not something that can be conveniently carried around a field or grove for a user to sequentially enter pest counts. One non-limiting embodiment of the sequential sampling system of the present invention is a wireless hand-held device that communicates with a laptop base station. In practice, the base station may be situated in a vehicle or carried on an ATV that could move through the sampling environment. The hand-held device would transmit input data from the user to the base station where it would be processed in real time. The base station would send messages back to the hand-held device which would display to the user an instruction as to whether or not to take an additional sample (i.e., an additional sample point is needed). The message exchanges between the hand-held device and the base station would continue until the sampling protocol declares one or the other of two hypothesis more likely to be true.

Implementing sequential sampling protocols to distinguish between two alternative hypotheses has been impeded by the complex mathematics that underlies the interpretation of their properties, as well as those involved in constructing their sampling boundaries. A further impediment has been the logistics of collecting data in a sequential manner. Thus, fixed sample size protocols have been more convenient for practitioners because of the lack of a mechanism to implement the dynamic decision making process associated with the sequential plans.

The present invention includes a software tool (for example, using Java programming language) that facilitates an easier use of sequential sampling methods, and enables a convenient platform for carrying out sequential inference. As can be appreciated by one having ordinary skill in the art, a non-limiting embodiment of the software tool of the present invention may be configured in a base station component of the sequential sampling system that communicates with a laptop computer. Another embodiment incorporates the software tool in a handheld device, such as a UMPC or other self-contained computer system.

The software tool supports SPRT (FIG. 1), 2-SPRT (FIG. 2) and sequential sampling protocols for a variety of statistical distributions including Bernoulli, binomial, Poisson, negative binomial and normal. For different combinations of sampling protocol and distribution, the tool graphically displays the sampling boundaries and provides a menu of options that allows the user to explore the statistical properties of the sampling design. For example, the user has easy access to the ASN (the average sample size), Type-1 error and Type-2 error for the design. It displays the boundary lines for the specific design and allows the user to plot and visualize each sample point incrementally and contemporaneously (i.e., one-at-time) as each sample unit is taken and counted (n,Sₙ). The software will prompt the user to take another sample, which is then counted and plotted until the point crosses the upper or lower boundary line. When the points cross over one of the two boundaries, the tool alerts the user to which of the two alternative hypotheses is more likely.

Software for the prototype tool was designed using a “R” package or custom programmed using Java programming language and libraries as a data processing engine mounted on a “TclTk” or Java programming graphical user interface. The TclTk package provides a rich array of graphical user interfaces to R software. The custom programmed software in Java programming language provides the advantages of independence with computing platform (i.e. hardware and operating system), smaller program size, higher efficiency in memory allocation, capable of migrating to an Internet web base system, and being integrated into other software as an add-on tool.

FIG. 3 shows a screenshot of the opening window of the sequential sampling tool of the present invention. The “Design” menu has a sub-menu that allows the user to specify the use of either the SPRT or 2-SPRT sampling protocol and an additional sub-menu to specify the distribution model for the data (i.e., Bernoulli, binomial, Poisson, negative binomial and normal distributions). For example, if the user selects a “Normal” distribution from the pull-down menu, then the ‘Normal Settings’ panel would allow selection of SPRT, 2-SPRT or Sequential Bayes sampling protocols. The “Examine” menu displays information about the design concerning the ASN and the Type-1 and 2 error rates. As shown in FIG. 4, an operating characteristic (OC) curve and an average sample number (ASN) curve for the selected distribution and sampling protocol are displayed when the user selects “Examine” from the top menu bar that is displayed in FIG. 3.

Once the user has set up the boundaries, individual data points are entered using a ‘Enter Data’ box, as shown in FIG. 5. If the upper boundary has been crossed by the last point that was taken, then the software makes a decision to stop and reject the null hypothesis, as shown in FIG. 6. After one of the hypotheses has been selected, the tool allows the user to test the adequacy of the distribution that was assumed for the model. The “GOF” (goodness-of-fit) menu has a tool to perform goodness-of-fit tests for the assumed model, including a graphical display of a histogram showing expected values (computed under the model) for groups of possible values versus the observed values, see FIG. 7. The system of the present invention is configured to allow the user to employ the goodness-of-fit test at any time during the data collection process. Using features within the “File” menu (see FIG. 3), all of the text and graphics windows utilized by the tool can be saved to PDF files for inclusion into technical reports.

In one non-limiting embodiment of the sequential sampling system of the present invention is that the software may be configured to run on a lightweight laptop computer, and is therefore portable. For example, the sequential sampling system has been installed on a Dell Inspiron 700m machine, which measures eight inches by 11.5 inches and weighs less than six pounds. In such an embodiment, the sequential sampling system can be carried into the field on an ATV or quad (all terrain vehicle) and utilized by practitioners in real time. Optionally, the data can be collected independently, assimilated into a text file, and then imported into the tool for a batch-mode analysis.

A CGI (Common Gateway Interface) R software program running on the Apache web server could be accessed by a handheld device via a wireless network, such as IEEE 802.11a/b/g, to provide communication with a remote computer. With high-gain external antennas, the IEEE 802.11b protocol can be used in fixed point-to-point arrangements, typically at ranges up to eight kilometers, which is sufficient to support field sampling in a large grove. Using this mechanism, the user of the handheld device would only need to open a web browser and input data while the server would process the data and then send the results to the handheld's web browser. There are several advantages to this approach. The most obvious is the increased data processing speed gained by taking advantage of a more powerful computer. Additionally, a large portion of existing R software code will be reusable despite the fact that handheld devices currently do not support the requirements to run R software, making development both quicker and cheaper than developing new codes for the handheld.

In another non-limiting embodiment of the system of the present invention the sequential sampling system is configured in a handheld device. The Java base software can run on any handheld device that runs Windows XP series operating system. Accordingly, the Java base system of the present invention may be migrated to web base system such that the Java applications execute on web server computer which could be accessed by any computer. With the highly portability of Java, the current Java base system may be integrated into other software package as an add-on tool.

Accordingly, the Java base system of the present invention may execute on a web server computer that could be accessed by a handheld device via a wireless network, such as IEEE 802.11a/b/g, to provide communication with a remote computer. With high-gain external antennas, the IEEE 802.11b protocol can be used in fixed point-to-point arrangements, typically at ranges up to eight kilometers, which is sufficient to support field sampling in a large grove. Using this mechanism, the user of the handheld device would only need to open a web browser and input data while the server would process the data and then send the results to the handheld's web browser. There are several advantages to this approach. The most obvious is the increased data processing speed gained by taking advantage of a more powerful computer.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a schematic diagram of a SPRT sampling protocol.

FIG. 2 is a schematic diagram of a 2-SPRT sampling protocol.

FIG. 3 is an opening window of a sequential sampling tool of the present invention depicting selecting Poisson distribution and then 2-SPRT sampling protocol.

FIG. 4 is operating characteristic (OC) curve and average sample number (ASN) curve for the selected distribution and sampling protocol.

FIG. 5 depicts entering data points sequentially for the selected distribution and sampling protocol.

FIG. 6 depicts how sampling terminates with a ‘reject’ decision due to upper boundary crossing.

FIG. 7 depicts graphical goodness-of-fit test after sampling terminates.

FIG. 8 is a flowchart of the steps of the Sequential Bayes Algorithm.

FIG. 9. is a block diagram of the sequential sampling tool architecture of the present invention.

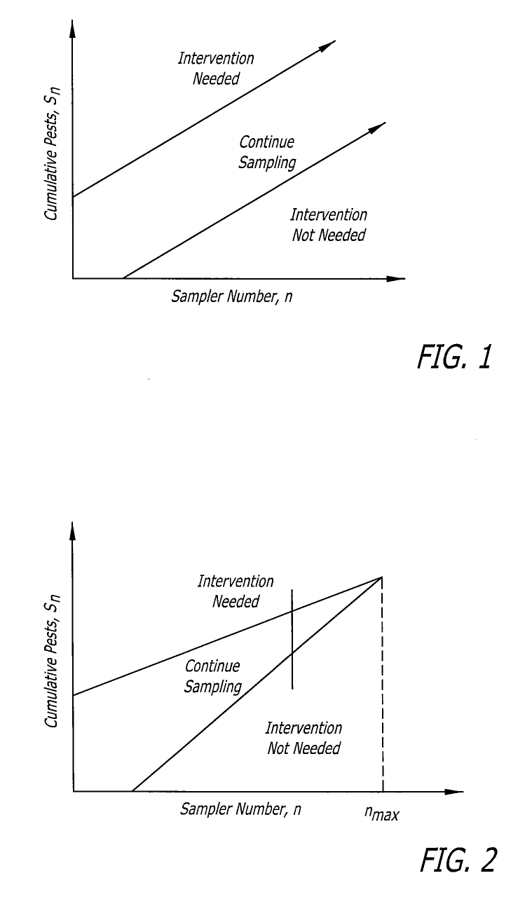

### DETAILED DESCRIPTION OF THE INVENTION

The system and method of the present invention is directed to a sequential sampling tool that executes advanced sequential protocols on a portable platform. The system includes a computer and software code compiled with well-known statistical and graphical user interface packages. The sampling and testing tool supports SPRT, 2-SPRT, and sequential Bayes sampling protocols for a variety of statistical distributions, including Bernoulli, binomial, Poisson, negative binomial, and normal distributions. The user has easy access to properties of the statistical design, such as average sample size curve, the operating characteristic curve, and the Type-1 and Type-2 error rates. The system also displays two boundary lines for the design, and allows the user to plot and visualize each observation point one-at-a-time as each sample unit is taken and counted.

### 1. Introduction

In most statistical analyses the data is collected using a fixed sample size and then analyzed using the complete dataset. In contrast, sequential sampling takes one sample at a time and analysis is performed at each step. Sampling in this way continues until sufficient information in the cumulative sample is obtained to make an appropriate decision using statistical inference. Thus, by using sequential sampling instead of fixed samples, one can draw conclusions during the data collection and often reach a decision more quickly. Sequential inference methods have the potential to greatly reduce the time and costs associated with decision making processes. As a result, they are applied to a variety of different fields such as Entomology, where the average pest density number is the parameter of interest, and to the study of clinical trials.

The mathematics associated with designing and utilizing sequential procedures can be complex for practitioners, and as such can dissuade users from availing themselves of the advantages they offer. The present invention is directed to a software tool that facilitates an easier use of the methods, and enables a convenient platform for carrying out sequential inference. The tool implements the appropriate inference procedures associated with each design within an innovative and scalable software architecture. It also hides the complex mathematics of the designs, and provides a user-friendly interface to design a sequential sampling scheme, understand its important statistical properties, and implement the scheme on real data.

The methods discussed in this specification have been incorporated in the software tool of the present invention. The remainder of this specification will be outlined in the following sections. Section 2 discloses several methods for the analysis of the sequential data. Section 3 discloses the design and development of the software tool that implements these methods under different probability models with different choice of parameters. Section 4 presents the analysis performed with this software tool using a example data set.

### 2. Sequential Testing Methods

Very often one encounters the classical hypothesis testing problem where Xᵢ˜F(μ), i=1, . . . N and one wishes to test,
H₀:μ=μ₀ vs. H₁:μ=μ₁ (1)

A typical test procedure in this situation utilizes a fixed-size sample that controls the Type-1 error and otherwise minimizes the Type-2 error. However in most real life situations it is neither time nor cost effective to obtain all the data points to test the hypothesis for the parameter of interest. In such situations one must develop a testing procedure that tests the hypothesis as each data point is collected. Fundamental work has been done in this area by (see Wald, A., Sequential Analysis, Dover Publications, 1947, incorporated herein in its entirety by reference).

2.1 The Basic SPRT

At each stage of the test, an observation is taken from the population under consideration and the likelihood ratio

$${λ}_{n} = {\prod }_{i = 1}^{n} \frac{f ( {x}_{i} , {μ}_{1} )}{f ( {x}_{i} , {μ}_{0} )} \qquad ( 2 )$$

is constructed.
Based on the values of the likelihood ratio, one of the following decisions is made:
Accept H₀ if λₙ≦A
Reject H₁ if λₙ≧B (3)
The critical values A and B are chosen using the Wald's approximation (Wald, 1947).

$$A = \frac{1 - β}{α} ; B = \frac{β}{1 - α} \qquad ( 4 )$$

in order to achieve
Pr(Reject H₀|H₀)≦α
Pr(Reject H₁|H₁)≦β (5)

It can be seen from (Lehman, E., Testing Statistical Hypothesis, p. 198, Th 8, Wiley, 1959, incorporated herein in its entirety by reference) that the SPRT with error probabilities α and β minimizes both E(N|μ₀) and E(N|μ₁). It is seen that the sequential technique in (1) saves one from a taking all the observations. However for the given values of parameters in the null and the alternative hypotheses the average sample number required take a decision by (1) can be quite high. Thus there lies a need to find a test from a family of tests T satisfying (5) and minimizing the average sample number (ASN), i.e.,

$$N ( {t}^{*} ) = {Min}_{t ∈ T} {Max}_{μ} ASN ( t , μ ) \qquad ( 6 )$$

The above is called the Keifer-Weiss problem, the asymptotic solution to which is given by (Lorden, G., 2-SPRT and the Modified Kiefer-Weiss Problem of Minimizing the Expected Sample Size, Annals of Statistics, 4, pp. 281-291, 1976, incorporated herein in its entirety by reference). This is explained by the 2-SPRT in the next section.

2.2 2-SPRT

2-SPRT requires the specification of a third point μ*ε[μ₀, μ₁] such that two likelihood ratios can now be defined as,

$${λ}_{0 n} = {\prod }_{i = 1}^{n} \frac{f ( {x}_{i} , {μ}_{0} )}{f ( {x}_{i} , {μ}^{*} )} ; {λ}_{1 n} = {\prod }_{i = 1}^{n} \frac{f ( {x}_{i} , {μ}_{1} )}{f ( {x}_{i} , {μ}^{*} )} \qquad ( 7 )$$

are constructed. Based on the likelihood ratios one of the following decisions is taken:
Accept H₀ if λ₁ₙ≦B
Reject H₀ if λ₀ₙ≦A (8)
Continue sampling if neither inequality is satisfied.

Similar to the well known inequalities of SPRT it can be shown that

$$\frac{α}{A} \leq Pr ( Accepting {H}_{0} \vert {μ}^{*} ) , \\ \frac{β}{B} \leq Pr ( Accepting {H}_{1} \vert {μ}^{*} ) \\ Pr ( Accepting {H}_{0} \vert {μ}^{*} ) + Pr ( Accepting {H}_{1} \vert {μ}^{*} ) = 1 \qquad ( 9 )$$

One strategy is to choose Pr(Accepting H₀|μ*)==Pr(Accepting H₁|μ*)=0.5, in which case the 2-SPRT is said to be balanced. In this situation we would approximately have,
A≈2α,B≈2β (10)
The μ* that gives the balanced 2-SPRT is obtained by solving the equation,

$$\frac{log ( \frac{1}{2 α} )}{I ( {μ}^{*} , {μ}_{0} )} = \frac{log ( \frac{1}{2 β} )}{I ( {μ}^{*} , {μ}_{1} )} \\ where \\ I ( {μ}^{*} , {μ}_{i} ) = E [ log ( \frac{f ( X ; {μ}^{*} )}{f ( X ; {μ}_{i} )} ) \vert {μ}^{*} ] \qquad ( 11 )$$

2.3 Sequential Bayes Procedure

In the previous two sections the sequential techniques used to make a decision on the parameter of interest have been disclosed. However there are many multi-parameter distributions, that one might encounter. In these situations we are faced with a problem of dealing with the nuisance parameters which we are not interested in. Using the procedures mentioned in (3) and (8), one needs to specify value of these parameters beforehand, which most of the time is a difficult job to do precisely.

We assume that Xᵢ˜F(Θ)), Θ=(μ,δ) where μ is the parameter of interest and δ is the nuisance parameters. In order to get around the difficulty posed by the nuisance parameters, we assume a discrete prior
Pr(μ=μ₁,δ=δⱼ)=g(μᵢ,δⱼ) (12)
where i, jε{0,1}×{l, . . . , n}. Though we propose a discrete prior in (12), one may also use a continuous prior. Having chosen the prior the posterior probabilities of the parameters can be computing taking in the observations sequentially. Therefore for the k^{th} observation, the joint posterior probability
p(μᵢ,δⱼ|xₖ, . . . , x₁)∝ƒ(x₁, . . . , xₖ|μᵢ,δⱼ)·g(μᵢ,δⱼ)

The marginal posterior probability for μᵢ's are computed as,

$$p ( {μ}_{i} \vert {x}_{k} , … , {x}_{1} ) ∝ {\sum }_{i = 1}^{n} p ( {μ}_{i} , {δ}_{j} \vert {x}_{k} , … , {x}_{1} ) . \qquad ( 13 )$$

At each observation xₖ, the posterior probabilities of the parameter under the null and alternative are compared with a certain cutoff ρ, and the one that is greater than ρ is accepted. If none of the posterior probabilities is greater than the cut off point we continue to take another observation and use the posterior probabilities for the k^{th} observation as the prior probabilities for the k+1^{th} observation.

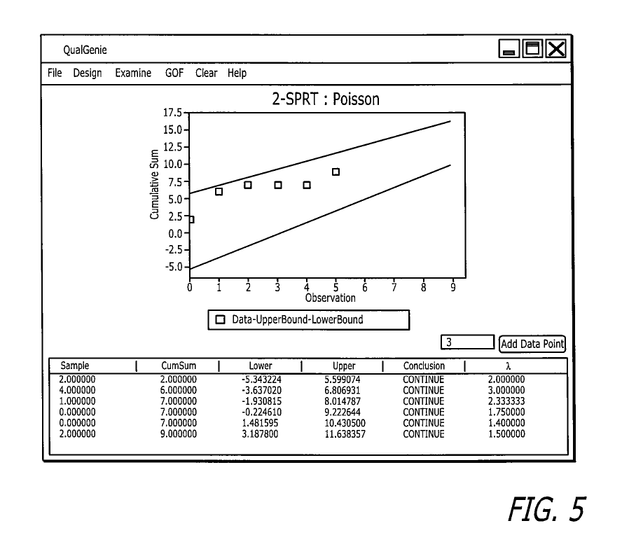

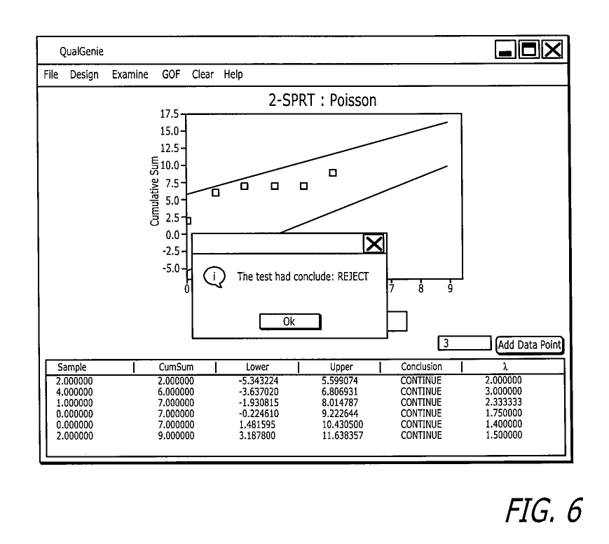

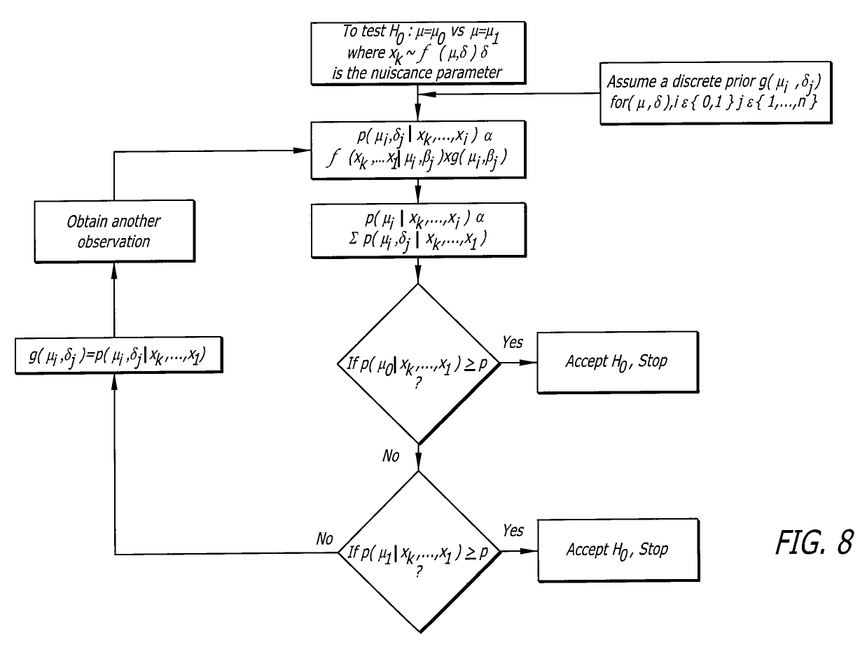

FIG. 5 presents the sampling boundaries for a 2-SPRT protocol, assuming the samples to be coming from a Poisson distribution. In the Sequential Bayes technique (FIG. 8), the scale parameter is assumed to equally likely among the values 1, 2, and 3 apriori. Both the null and alternative values of the location parameter are assumed to be equally likely apriori.

As shown in FIG. 8, Step 1 of the Sequential Bayes technique depicts insertion of the prior probabilities of all the parameters involved in the model. Step 2.1 depicts evaluation of the joint posterior probability of the parameter of interest and the nuisance parameters using the prior probabilities and the likelihood of an observation under the model. Step 2.2 depicts evaluation of the marginal posterior probability of the parameter of interest. Step 3.1 and 3.3 depict comparison of the posterior probability of each of the two parameter values under the null and the alternative hypothesis with a chosen rho, in order to make a decision on the hypothesis testing. Step 4 represents a feedback mechanism by which a posterior probability obtained in the previous step is reinserted as the prior probability in the next step which along with a new observation is used to compute the new posterior probabilities.

Note that unlike the normal SPRT, the 2-SPRT produces two converging sampling boundaries which assure the decision for the test of hypothesis within a finite sample. Unlike the SPRT and 2-SPRT the Sequential Bayes technique defines the sampling boundaries in terms of the posterior odds ratios (POR) of the alternative vs. the null. Although the Sequential Bayes allows the anonymity of the scale parameter, it requires higher sample sizes than the other two techniques. The next section presents the details if the design and the architecture of the software tool developed to facilitate this kind of a sequential analysis.

### 3. Sequential Analysis Tool

The motivation behind designing the sequential sampling software tool has been to provide an interface between the practitioner who can use this tool to perform sequential analysis. Another important consideration that has gone into the design is that it is envisioned to be a tool that can be used in a fully portable environment. Different embodiments of the sequential sampling tool have been able to executed on portable laptops and handheld computers (e.g., UMPC) that runs Windows XP series and Linux operating system.

The sequential sampling tool of the present invention has been designed using R software and Java programming language in separate embodiments as the main programming support for all the statistical functions and other computational tasks associated with the tool. The graphics user interface (GUI) has been designed using TclTk software and Java programming language in separate embodiments.

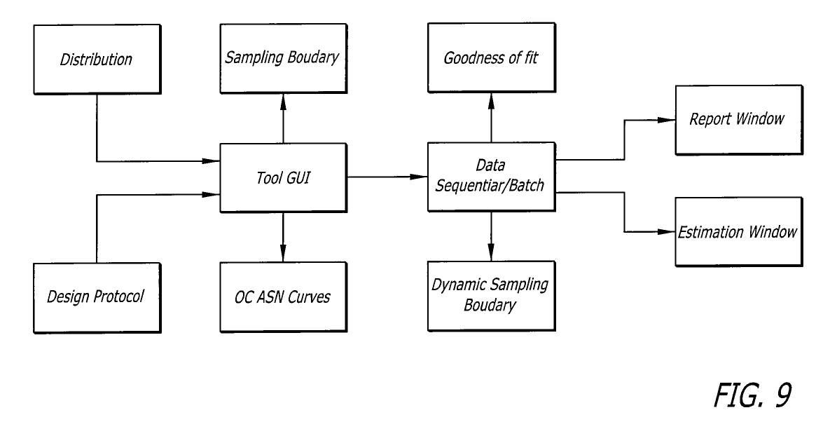

FIG. 9 presents the overall architecture of the sequential sampling tool of the present invention. It can be observed that the tool first requires the user to input the sampling protocol and the distribution along with its associated parameters. In one embodiment of the present invention, the sequential sampling tool supports all the three sampling protocols discussed in Section 2. It supports two discrete distributions namely the Poisson and Bernoulli and two continuous distributions, i.e., Gaussian and Negative Binomial. It is to be noted that most of the results here are presented using the negative binomial distribution, the reason being that this project is originally attributed to the Entomologists who find the negative binomial distribution as the pertinent one.

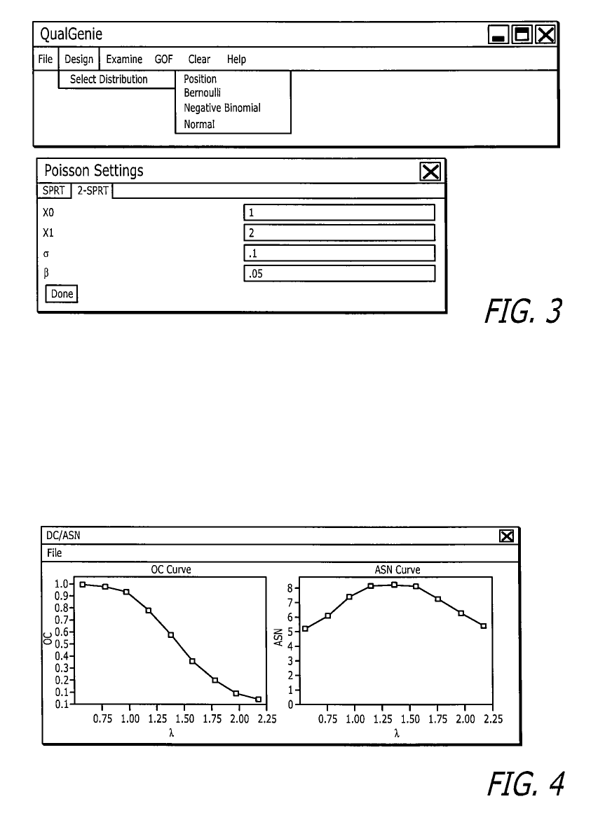

FIG. 3 is an example screenshot of the tool showing the steps that the user must follow to input the design and distributions components of the tool. This initialization step can be executed by clicking the Design tab on the top menu as shown in FIG. 3.

Note that unless these two key components are input, the sequential sampling tool will not be initialized and hence all the output options of it will continue to be disabled. Having initialized the tool, it is now ready to show the corresponding the OC and ASN curves associated with the parameters. These curves can be seen by clicking on the “Examine” tab shown in FIG. 3. This tool uses large sample simulations, instead of the Wald's approximation to estimate the OC and the ASN curves. This is useful because we find that in most of the situations the Wald's approximation underestimates the ASN specially at the values of the parameter that lie middle of the null and the alternative.

At this junction it is worthwhile to note that the sequential sampling tool has been locked in for the given set of initial settings. If these settings need to be changed, the tool must be cleared of these settings, the option of which can been found on the “Clear” menu of the tool as shown in FIG. 3. It is also important for the user to remember that all the data that might have been input till this stage must be saved, before the clear option is invoked. The tool is now ready to take in the observation sequentially.

Data can be input sequentially using input field, as can be seen in FIG. 5. The sequential sampling tool has an exception handling mechanism built into it to verify the validity of every observation, in order to ascertain that every number input is a valid real number satisfying the support criteria for the distribution being used at that point.

Though the tool has been developed in a sequential flavor, it also allows for batch data input. This feature has been particularly incorporated to avoid entering the same data sequentially repeatedly for every different protocol. However the batch data produces all the output at the level of each observation in order to retain the sequential aspect of the tool. The batch input option can be selected through the “File” submenu shown in FIG. 3.

The input of the first data point, activates all the output features of this tool namely, Report, Estimation, Dynamic Sampling and the Goodness-of-Fit.

### 4. Results

In some embodiments of the sequential sampling system of the present invention, a “Report” window (not shown) may be configured to provide the lower and the upper boundary of the sampling boundary and sample number for each observation. The appropriate statistic for the sampling boundary being plotted may also presented in the Report window. In addition, the Report window may also provide a comment as to whether the user should accept or reject the null hypothesis or continue to sample more observations. The Report window may be dynamically updated as each observation is entered. Alternatively, the information for such a Report Window may be provided automatically and continuously as illustrated in the lower portion of FIG. 5.

In addition to the Report window, the sequential sampling system may be configured with an “Estimation” window (not shown) that dynamically updates the estimates of the parameters involved in the distribution as more observations are input. All the estimates of the parameters may be based on the maximum likelihood which are either computed analytically or numerically. Estimates of the scale parameter may be labeled as NA for the negative binomial distribution. It can be shown that m.l.e's of the scale parameter in the negative binomial case does not exist when the sample variance is lower than the sample mean. For example, it is important to observe the dynamic sampling boundaries. These boundaries change their scale adaptively as more observations are taken in. This allows the user to visually see where the observations stand cumulatively within the sampling boundaries. Alternatively, the information for such an Estimation Window may be provided automatically and continuously as illustrated in the lower portion of FIG. 5.

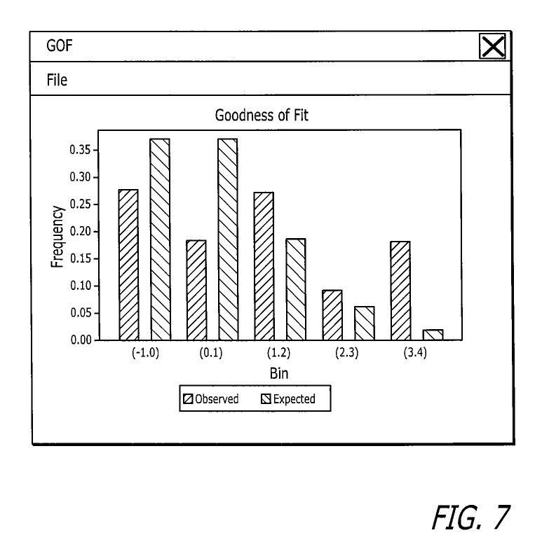

Besides the above windows, the sequential sampling tool of the present invention also has an option to look at the goodness-of-fit plot (FIG. 7) looking at the empirical histogram of the data and the expected histogram under the given distribution and the parameters in the null hypothesis.

### 5. Conclusion

The sequential analysis tool of the present invention not only allows the user to produce a variety of text based and graphics output but also provides the feature of saving all these results in appropriate file formats for future utility. The sequential sampling tool of the present invention has been developed in a open source framework to ensure that it can be scaled up for more sequential tests under different protocols and distributions by different sections. The sequential sampling system has been tested extensively on Dell Inspiron 700M notebook computers, Sony VAIO UX280P UMPC, desktop computers running Windows or Linux operating system. The performance of this tool so far has been satisfactory in most of the critical computation, especially the plot of the ASN and OC curve that require simulation runs.

The sequential sampling tool of the present invention contemplates additional features. One such feature would be to make the system more statistically involved, for example. The inclusion of additional sequential techniques used in other applied statistics areas such as clinical trials and quality control. Such a system of the present invention includes development of semi-parametric approach to do this kind of sequential analysis. Another contemplated feature of the system of the present invention would be to make the sequential sampling tool more computationally sophisticated. In order to avoid the bulk of the portable devices, one could think of a client-server model of this tool where by the end user would just need to type in the data through a portable device like a PDA, smartphones or any other handheld device. This data would then be sent to a server through a secure wireless connection, which would then return the results back to the client after the computation.

While particular forms of the present invention have been illustrated and described, it will also be apparent to those skilled in the art that various modifications can be made without departing from the spirit and scope of the invention. Accordingly, it is not intended that the invention be limited by the specific embodiments disclosed herein.

We claim:

1. A sequential sampling system, comprising:
a graphical user interface; and
a sequential sampling tool having software code including statistical packages and configured to interface with the graphical user interface, wherein the sequential sampling tool supports SPRT, 2-SPRT, and sequential sampling protocols for a variety of statistical distributions, including Bernoulli, binomial, Poisson, negative binomial, and normal distributions.

2. The sequential sampling system of claim 1, wherein the graphical user interface and the sequential sampling tool reside on a computer running a Microsoft Windows operating system.

3. The sequential sampling system of claim 1, wherein the graphical user interface and the sequential sampling tool reside on a computer running a Linux operating system.

4. The sequential sampling system of claim 1, wherein a user interface and portions of the sequential sampling tool reside on a wireless hand-held device that communicates with a laptop base station configured with a graphical user interface and software code compiled with statistical packages.

5. The sequential sampling system of claim 1, wherein the user interface and the sequential sampling tool are programmed using a Java programming language.

6. The sequential sampling system of claim 1, wherein a user interface and portions of the sequential sampling tool are programmed using a Java programming language and reside on a ultra mobile personal computer.

7. A method for sequential sampling, comprising:
providing a graphical user interface;
providing a sequential sampling tool having software code including statistical packages and configured to interface with the graphical user interface, wherein the sequential sampling tool supports SPRT, 2-SPRT, and sequential sampling protocols for a variety of statistical distributions, including Bernoulli, binomial, Poisson, negative binomial, and normal distributions; and
sequential entering data into the sequential sampling tool.
